(19) United States
(12) Patent Application Publication
(10) Pub. No.: US 2025/0356825 A1
(43) Pub. Date: Nov. 20, 2025

(54) Portable Drum Kit Case with Integrated Riser Platform

(71) Applicant: Carl DeScott, Cleveland, OH (US)

(72) Inventor: Carl DeScott, Cleveland, OH (US)

(21) Appl. No.: 18/938,412

(22) Filed: Nov. 6, 2024

Related U.S. Application Data
(60) Provisional application No. 63/647,695, filed on May 15, 2024.

(51) Int. Cl. G10G 7/00; G10D 13/10; G10G 5/00

(52) U.S. Cl. CPC G10G 7/005; G10D 13/10; G10G 5/005

(57) ABSTRACT

A drum kit/set case riser device designed for storing, transporting, and supporting an assembled drum set is disclosed. The device features a bottom panel with a non-slip surface to stabilize the drum set, and a plurality of removable panels including a top panel, side panels, and a front panel that securely enclose the drum set during transport. A pivoting rear panel is folded out to extend the riser platform and is supported by transitional bars for added stability. The device includes lockable casters for easy maneuverability and a motorized mechanism with a control button for automated opening and closing of the panels. Additionally, an integrated subwoofer provides audio support. The invention allows for quick transition between an assembled state for transport and an unassembled state for performance, offering a portable, secure, and convenient solution for musicians.

### CROSS-REFERENCE TO RELATED APPLICATION

The present application claims priority to, and the benefit of, U.S. Provisional Application No. 63/647,695 which was filed on May 15, 2024, and is incorporated herein by reference in its entirety.

### FIELD OF THE INVENTION

The present invention generally relates to the field of musical instrument transportation and performance equipment. More specifically, the present invention relates to a drum kit/set case riser device designed to provide an integrated solution for the storage, transportation, and performance setup of a drum kit. The device features a combination of removable panels and a pivoting rear panel that transitions the case into an elevated riser platform, enhancing the sound quality and stage presence of the drum kit during performances. The system includes lockable casters for easy maneuverability, a non-slip surface for stability, and an optional motorized mechanism for automated setup. Accordingly, the present disclosure makes specific reference thereto. It is to be appreciated that aspects of the present invention are also equally applicable to other like applications, devices, and methods of manufacture.

### BACKGROUND

By way of background, transporting and setting up a full drum kit for a live performance can be a challenging and time-consuming task for musicians. Traditional methods often require multiple trips to and from a vehicle or storage area to bring all the necessary components of the drum kit into the venue. The process is not only exhausting but also inefficient, especially in time-sensitive situations such as sound checks or last-minute preparations before a show.

Furthermore, when a drum kit is placed directly on the ground rather than on a properly elevated riser, the sound quality can be significantly compromised. The drums may produce a muffled sound, and the overall projection and resonance can be reduced, which negatively impacts the performance. A riser is essential for optimizing the acoustic properties of the drum kit, allowing it to be heard clearly by the audience and providing the drummer with a better playing experience.

However, the construction of a traditional drum riser typically involves assembling multiple parts, such as wooden platforms, support structures, and securing hardware. The process is labor-intensive and requires careful planning to ensure that all parts are brought to the venue. Any missing or forgotten components can lead to malfunctions or inconveniences during the performance, which can disrupt the show and cause unnecessary stress for the performers. People desire a more efficient, portable, and reliable solution to transport, set up, and elevate a drum kit.

Therefore, there exists a long-felt need in the art for a drum kit storage and transportation device that allows for quick and efficient setup and teardown at performance venues. There is also a long-felt need in the art for a solution that eliminates the need for multiple trips to transport a drum kit, thereby reducing the physical strain and time required for setup. Additionally, there is a long-felt need in the art for a device that provides a stable and elevated platform for drum kits to enhance sound quality and projection during performances. Moreover, there is a long-felt need in the art for a drum kit riser that integrates seamlessly into the transportation case. Furthermore, there is a long-felt need in the art for a drum kit/set case that is robust, secure, and capable of protecting the drum set during transport while being easy to maneuver. Finally, there is a long-felt need in the art for an innovative drum kit/set case and riser combination that offers a portable, reliable, and efficient solution to the challenges faced by drummers in transporting and setting up their instruments.

The subject matter disclosed and claimed herein, in one embodiment thereof, comprises a drum kit/set case riser device designed to address these long-standing challenges faced by drummers. The device includes a bottom panel with a non-slip surface that serves as a stable platform for the drum set. The device further comprises a set of removable panels including a top panel, side panels, and a front panel, which can be securely attached to the bottom panel to encapsulate the drum set during transport. A pivoting rear panel is also included, which can be folded out to extend the riser platform, thereby providing an elevated stage for performances. The device is equipped with lockable casters to facilitate easy movement and ensure stability when in use.

In this manner, the drum kit/set case riser device of the present invention accomplishes all of the foregoing objectives and provides a novel solution that simplifies the transportation and setup of drum kits. The device integrates a storage case and riser into a single unit, allowing drummers to efficiently transport their equipment in one trip and quickly transition from transport to performance mode. The pivoting rear panel, when folded out, extends the riser platform, enhancing the sound quality and stage presence of the drum kit. The drum kit/set case riser device offers a reliable, efficient, and innovative solution to the logistical challenges drummers face, streamlining the process of setting up for live shows and studio sessions.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a drum kit/set case riser device. The device comprises a bottom panel having a top surface and a bottom surface, said bottom panel configured to support a drum set, a removable top panel, a pair of removable side panels, a removable front panel, a pivoting rear panel, wherein said pivoting rear panel is configured to fold out and become coplanar with said bottom panel to extend a riser platform, a plurality of casters disposed on the bottom surface of said bottom panel, wherein said casters are lockable to prevent movement during use, and one or more handles attached to the side panels for maneuvering the device.

In yet another embodiment, a drum kit/set case riser device is disclosed. The device comprises a bottom panel configured to support a drum set, a plurality of detachable panels, including a top panel, side panels, and a front panel, all removably attachable to said bottom panel, a rear panel pivotally connected to said bottom panel, wherein said rear panel is adapted to fold out and extend the surface area of the bottom panel, supporting bars attached to said rear panel, wherein said bars are adapted to transition from a position flush with the rear panel to a position transverse to the rear panel for supporting said rear panel when the rear panel is folded out, and a non-slip surface on the top surface of said bottom panel for stabilizing the drum set during use.

In another embodiment, a drum kit/set case riser device is disclosed. The device comprises a bottom panel having a top surface for supporting a drum set, a removable top panel, a pair of removable side panels, a removable front panel, a pivoting rear panel, a plurality of casters disposed on the bottom surface of said bottom panel, a motor adapted to automatically open and close said panels, a control button operatively connected to said motor for initiating the opening and closing of said panels, and a subwoofer integrated into the bottom panel, providing audio support for the drum set.

In still another embodiment, a method of using a drum kit/set case riser device is disclosed. The method comprises the steps of placing a drum set on a bottom panel of the drum kit/set case riser device, securing a removable top panel, a pair of removable side panels, and a removable front panel to the bottom panel to encapsulate the drum set within the drum kit/set case riser device, transporting the drum kit/set case riser device to a performance location using a plurality of casters disposed on the bottom surface of the bottom panel, unlocking and removing the top panel, side panels, and front panel to expose the drum set, pivoting a rear panel connected to the bottom panel to extend the bottom panel and create an extended riser platform, playing the drum set while it is supported on the riser platform, and reattaching the top panel, side panels, and front panel to the bottom panel after the performance to enclose the drum set.

In still another aspect, a drum kit/set case riser device capable of transitioning between an assembled state and an unassembled state is disclosed. The riser device comprises a bottom panel configured to support a drum set, a plurality of removable panels including a top panel, side panels, and a front panel, wherein, in the assembled state, the removable panels are securely attached to the bottom panel to encapsulate the drum set, and in the unassembled state, the removable panels are detached from the bottom panel to expose the drum set, a pivoting rear panel, wherein in the unassembled state, the pivoting rear panel is folded out to become coplanar with the bottom panel, extending the surface area of the riser platform, and in the assembled state, the pivoting rear panel is folded back to align vertically with the bottom panel, a mechanism for locking the removable panels to the bottom panel in the assembled state and unlocking them to transition to the unassembled state, wherein the device is adapted to transition between the assembled state for transportation and storage of the drum set, and the unassembled state for use as an extended riser platform during performances.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of drum kit/set case riser device of the present invention in accordance with the disclosed structure;

FIG. 2 illustrates an exploded view of the drum kit riser and transportation device of the present invention showing the removable panels in accordance with one embodiment of the present invention;

FIG. 3 illustrates a perspective view showing a musician operating the drum set with the drum set riser device being in an unassembled state in accordance with the disclosed structure; and

FIG. 4 illustrates a perspective view of another embodiment of the drum set riser device in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a drum kit storage and transportation device that allows for quick and efficient setup and teardown at performance venues. There is also a long-felt need in the art for a solution that eliminates the need for multiple trips to transport a drum kit, thereby reducing the physical strain and time required for setup. Additionally, there is a long-felt need in the art for a device that provides a stable and elevated platform for drum kits to enhance sound quality and projection during performances. Moreover, there is a long-felt need in the art for a drum kit riser that integrates seamlessly into the transportation case. Furthermore, there is a long-felt need in the art for a drum kit/set case that is robust, secure, and capable of protecting the drum set during transport while being easy to maneuver. Finally, there is a long-felt need in the art for an innovative drum kit/set case and riser combination that offers a portable, reliable, and efficient solution to the challenges faced by drummers in transporting and setting up their instruments.

The present invention, in one exemplary embodiment, is a drum kit/set case riser device capable of transitioning between an assembled state and an unassembled state. The riser device comprises a bottom panel configured to support a drum set, a plurality of removable panels including a top panel, side panels, and a front panel, wherein, in the assembled state, the removable panels are securely attached to the bottom panel to enclose and store the drum set, and in the unassembled state, the removable panels are detached from the bottom panel to expose the drum set, a pivoting rear panel, wherein in the unassembled state, the pivoting rear panel is folded out to become coplanar with the bottom panel, extending the surface area of the riser platform, and in the assembled state, the pivoting rear panel is folded back to align vertically with the bottom panel, a mechanism for locking the removable panels to the bottom panel in the assembled state and unlocking them to transition to the unassembled state, wherein the device is adapted to transition between the assembled state for transportation and storage of the drum set, and the unassembled state for use as an extended riser platform during performances.

Reference will now be made in detail to the present preferred embodiments of the invention, examples of which are illustrated in the accompanying drawings. Wherever possible, the same reference numerals are used in the drawings and the description to refer to the same or like parts.

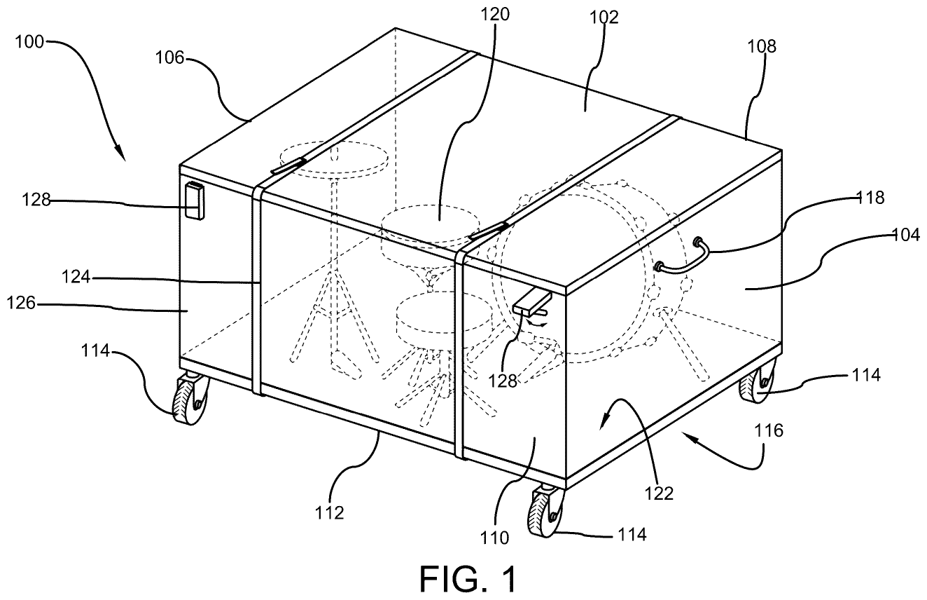

Referring initially to the drawings, FIG. 1 illustrates a perspective view of drum kit/set case riser device of the present invention in accordance with the disclosed structure. The drum kit/set case riser device 100 of the present invention is designed as a large, rectangular, or square (i.e., rectilinear) storage case to house an entire assembled drum set. The riser device 100 is preferably made of durable materials such as plywood, metal, or reinforced plastic to provide protection and stability during transport. More specifically, the riser device 100 has a removable or hinged top panel 102, a pair of removable or hinged side panels 104, 106, a removable or hinged front panel 108, a pivoting (i.e., hinged) rear panel 110, and a fixed bottom panel 112. The panels 102, 104, 106, 108, 110 are constructed to be sturdy to protect the drum kit from external impacts and provide rigidity to the device 100. It is to be appreciated that the panels 102, 104, 106, 108 can be hingedly connected (not illustrated) to the bottom panel 112 for pivoting thereto and for providing support to the riser device 100.

A plurality of casters 114 are disposed on the bottom surface 116 of the bottom panel 112. The casters 114 are used for easy maneuvering and transportability of the device 100 and the casters 114 can be locked to prevent movement when the drum set is in use on stage. The device 100 includes one or more is heavy-duty handles 118 on the sides for easy lifting and maneuvering. In the assembled state, the riser device 100 is used for storing a drum set 120 inside therein and the device 100 along with the stored drum set 120 can be easily transported. The wheels 114 allow the entire drum kit to be moved in a single trip, saving time and effort, particularly during live performances or studio sessions. The top surface 122 of the bottom panel 112 has a non-slip surface to ensure that the drum set remains stable during use.

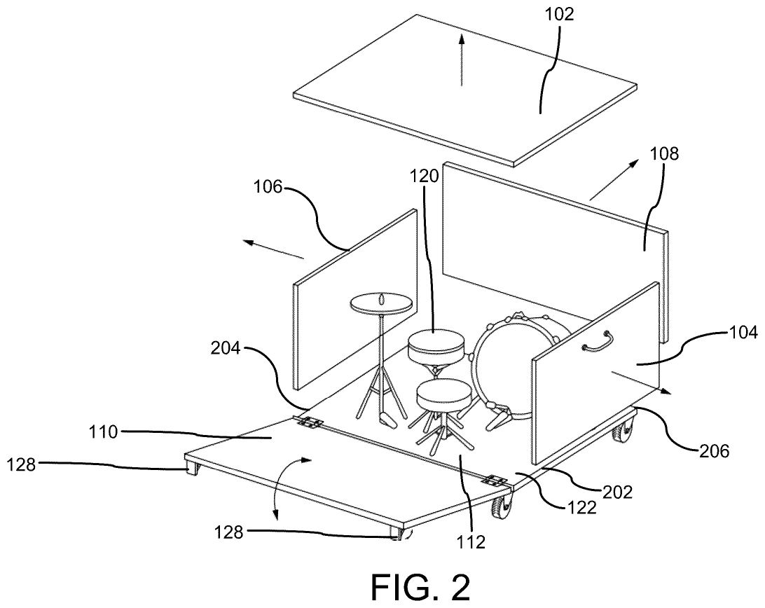

In the assembled state, the panels of the drum case riser device 100 are locked to each other and are further secured using one or more elastic straps 124 for preventing the panels from unintentional detachment. The straps 124 can be unlocked when the drum set 120 is to be used by a musician such as on a stage. It will be noted that the bottom panel 112 remains in place when the drum set rise case device 100 is opened and serves as a riser or platform for the drum set during performances. The outer surface 126 of the pivoting rear panel 110 includes a plurality of supporting bars 128 which are configured to adhere to the outer surface 126 when the riser device 100 is in the assembled state and can manually transition to become transverse to the outer surface 126 as illustrated in FIG. 2 when the pivoting rear panel 110 is pivoted to become coplanar to the fixed bottom panel 112. The coplanar pivoting rear panel 110 extends the bottom panel 112 effectively creating a larger riser.

FIG. 2 illustrates an exploded view of the drum kit riser and transportation device of the present invention showing the removable panels in accordance with one embodiment of the present invention. As illustrated, the bottom panel 112 includes a first side channel 202 for supporting and securing the first side wall 104 in the vertical position as illustrated in FIG. 1. Similarly, the bottom panel 112 includes a second side channel 204 for supporting and securing the second side wall 106. A front channel 206 is disposed along the front edge of the bottom panel 112 for securing and supporting the front panel 108. The panels 104, 106, 108 are detached from the bottom panel 112 by pulling them from the corresponding channels on the bottom panel 112. The channels can also be in the form of latches for secure connection with the bottom panel 112.

The top panel 102 is also removed for providing access to the drum set 120. The drum set 120 is placed on the bottom panel 112, thereby allowing access to a drummer while enabling audience to view the drum set. The bottom panel 112 remains in place and is adapted to serve as a riser. For extending the riser platform, the hinged side 110 can be folded out to extend the riser and the hinged side 110 is folded until the hinged side 110 becomes coplanar to the bottom panel 112. When the hinged side 110 is folded out, the supporting bars 128 are unfolded and become transverse to the hinged side 110 and rest on the floor to extend the riser platform.

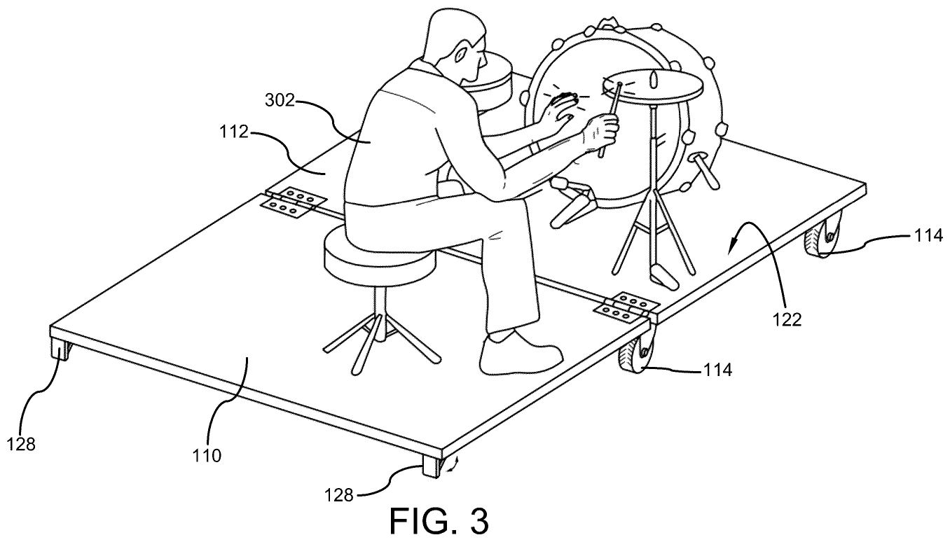

FIG. 3 illustrates a perspective view showing a musician operating the drum set with the drum set riser device being in an unassembled state in accordance with the disclosed structure. In the present embodiment, the portable drum kit/set case with integrated riser platform 100 is in the unassembled state as transitioned from the assembled state of FIG. 1. In the unassembled state, the hinged rear panel 110 is folded out and extended to extend the riser platform wherein the bottom panel 112 and the folded out rear panel 110 are coplanar and the musician 302 can sit on the rear panel 110 for playing the drum set 120. In the unassembled form, the wheels 114 are locked and the rear panel 110 is supported by the supporting bars 128. Using the riser device 100 in the unassembled state, the drum set 120 can be easily used which is positioned on a stable and slightly elevated platform that enhances the performance setup. After the performance, the panels can be reattached to the bottom panel 112 thereby enclosing the drum set once again.

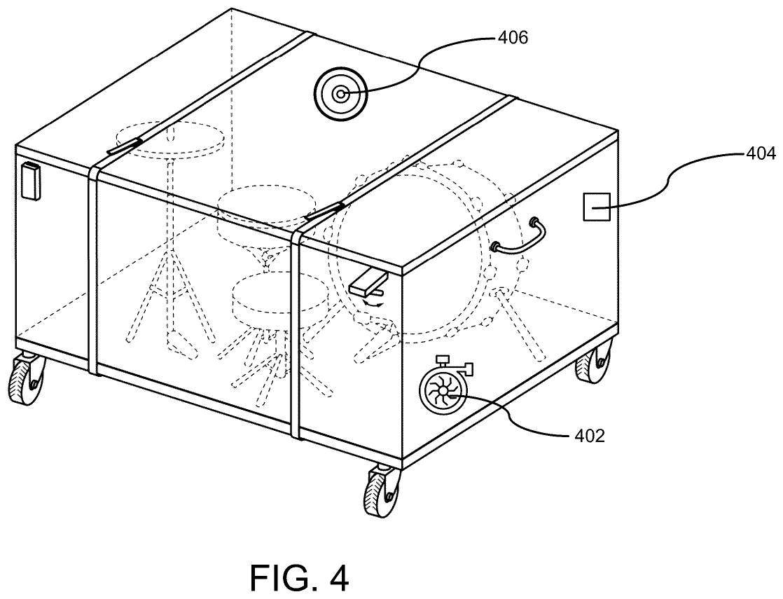

FIG. 4 illustrates a perspective view of another embodiment of the drum set riser device in accordance with the disclosed structure. In the present embodiment, the device 100 includes a motor 402 that is adapted to automatically open and close the panels of the device 100. A control button 404 is disposed on the device 100 for unfolding and setting up the drum kit, reducing setup time and effort. A subwoofer 406 is integrated in the drum kit riser and transportation device 100 for providing audio support for the drum kit.

In some embodiments, the portable drum kit/set case with integrated riser platform 100 of different embodiments may include self-leveling feet that automatically adjusts to uneven surfaces, thereby enabling the drum kit to be stable during performances. A biometric fingerprint or facial recognition module can be integrated to secure the riser device 100 enabling only authorized users to open the device.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “portable drum kit/set case with integrated riser platform”, “drum kit riser and transportation device”, “drum kit/set case riser device” and “riser device” are interchangeable and refer to the portable drum kit/set case with integrated riser platform 100 of the present invention.

Notwithstanding the forgoing, the portable drum kit/set case with integrated riser platform 100 of the present invention can be of any suitable size and configuration as is known in the art without affecting the overall concept of the invention, provided that it accomplishes the above stated objectives. One of ordinary skill in the art will appreciate that the portable drum kit/set case with integrated riser platform 100 as shown in the FIGS. are for illustrative purposes only, and that many other sizes and shapes of the portable drum kit/set case with integrated riser platform 100 are well within the scope of the present disclosure. Although the dimensions of the portable drum kit/set case with integrated riser platform 100 are important design parameters for user convenience, the portable drum kit/set case with integrated riser platform 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A drum kit case riser device comprising:
a rectilinear storage case for housing an assembled drum set; and
a plurality of casters;
wherein said rectilinear storage case having a removable top panel, a pair of removable side panels, a removable front panel, a pivoting rear panel, and a bottom panel;
wherein said rectilinear storage case convertible from a closed assembled configuration to an opened disassembled configuration;
wherein said rectilinear storage case is rigid;
wherein the assembled drum set contained within said rectilinear storage case in said closed assembled configuration;
wherein a top surface of said bottom panel having a non-slip surface for stabilizing the assembled drum set;
wherein said bottom panel remains in place when the drum kit case riser device is opened;
wherein said pivoting rear panel having an outer surface including a plurality of supporting pivoting bars;
wherein said supporting pivoting bars support said pivoting rear panel to a coplanar orientation with said bottom panel when said pivoting rear panel is pivoted to a horizontal position; and
further wherein said bottom panel and said pivoting rear panel when opened serve as a planar platform for the assembled drum set during use.

2. The drum kit case riser device of claim 1, wherein said supporting pivoting bars aligned with said pivoting rear panel when the drum kit case riser device is closed, and further wherein said supporting bars transverse with said pivoting rear panel when the drum kit case riser device is opened.

3. The drum kit case riser device of claim 1, wherein said plurality of casters disposed on a bottom surface of said bottom panel.

4. The drum kit case riser device of claim 1, wherein said plurality of casters are selectively lockable to prevent movement of said rectilinear storage case.

5. The drum kit case riser device of claim 1, wherein each of said pair of side handles having a handle.

6. The drum kit case riser device of claim 1, wherein said rectilinear storage case having a plurality of elastic straps surrounding said rectilinear storage case during transport.

7. The drum kit case riser device of claim 1, wherein said rectilinear storage case having a material selected from the group consisting of a plywood, a metal, and a reinforced plastic.

8. The drum kit case riser device of claim 1, wherein said removable top panel, said pair of removable side panels, and said removable front panel selectively removable when the drum kit case riser device is opened.

9. A drum kit case riser device comprising:
a rectilinear storage case for housing an assembled drum set; and
a plurality of casters;
wherein said rectilinear storage case having a top panel, a pair of side panels, a front panel, a pivoting rear panel, and a bottom panel;
wherein said rectilinear storage case convertible from a closed assembled configuration to an opened disassembled configuration;
wherein the assembled drum set contained within said rectilinear storage case in said closed assembled configuration;
wherein said bottom panel remains in place when the drum kit case riser device is opened;
wherein said pivoting rear panel having an outer surface including a plurality of supporting pivoting bars;
wherein said supporting pivoting bars support said pivoting rear panel to a coplanar orientation with said bottom panel when said pivoting rear panel is pivoted to a horizontal position;
wherein said bottom panel and said pivoting rear panel when opened serve as a planar platform for the assembled drum set during use; and
further wherein at least one of said bottom panel and said pivoting rear panel supporting a drum musician thereon during use of the assembled drum set.

10. The drum kit case riser device of claim 9, wherein said supporting pivoting bars aligned with said pivoting rear panel when the drum kit case riser device is closed, and further wherein said supporting bars transverse with said pivoting rear panel when the drum kit case riser device is opened.

11. The drum kit case riser device of claim 9, wherein said plurality of casters disposed on a bottom surface of said bottom panel.

12. The drum kit case riser device of claim 9, wherein said plurality of casters are selectively lockable to prevent movement of said rectilinear storage case.

13. The drum kit case riser device of claim 9, wherein each of said pair of side panels having a handle.

14. The drum kit case riser device of claim 9, wherein said rectilinear storage case having a plurality of elastic straps surrounding said rectilinear storage case during transport.

15. The drum kit case riser device of claim 9, wherein said rectilinear storage case is rigid, and further wherein said rectilinear storage case having a material selected from the group consisting of a plywood, a metal, and a reinforced plastic.

16. The drum kit case riser device of claim 9, wherein said top panel, said pair of side panels, and said front panel selectively removable when the drum kit case riser device is opened.

17. A method of using a transportable drum kit case riser device, the method comprising the steps of:
providing a rectilinear storage case and a plurality of casters for housing an assembled drum set, wherein said rectilinear storage case having a top panel, a pair of side panels, a front panel, a pivoting rear panel, and a bottom panel, wherein said rectilinear storage case convertible from a closed assembled configuration to an opened disassembled configuration, wherein said bottom panel remains in place when the drum kit case riser device is opened, wherein said pivoting rear panel having an outer surface including a plurality of supporting pivoting bars;
containing the assembled drum set within said rectilinear storage case in said closed assembled configuration;
pivoting said pivoting rear panel to a coplanar orientation with said bottom panel when said pivoting rear panel is pivoted to a horizontal position, wherein said plurality of supporting bars movable from an aligned position with said bottom panel to a transverse position with said bottom panel, wherein said bottom panel and said pivoting rear panel when opened serve as a planar platform for the assembled drum set during use; and
supporting a drum musician on at least one of said bottom panel and said pivoting rear panel during use of the assembled drum set when said rectilinear storage case is in said opened dissembled configuration.

18. The method of using a transportable drum kit case riser device of claim 17, wherein said plurality of casters disposed on a bottom surface of said bottom panel, and further wherein said plurality of casters are selectively lockable to prevent movement of said rectilinear storage case.

19. The method of using a transportable drum kit case riser device of claim 17, wherein said rectilinear storage case is rigid, and further wherein said rectilinear storage case having a material selected from the group consisting of a plywood, a metal, and a reinforced plastic.

20. The method of using a transportable drum kit case riser device of claim 17, wherein said top panel, said pair of side panels, and said front panel selectively removable when the drum kit case riser device is in said opened dissembled configuration.
